(19) United States
(12) Patent Application Publication
(10) Pub. No.: US 2006/0018128 A1
(43) Pub. Date: Jan. 26, 2006

(54) Flat-type light source device and liquid crystal display device having the same

(76) Inventors: Hae-Il Park, Seoul (KR); Sang-Yu Lee, Yongin-si (KR); Hyoung-Joo Kim, Uiwang-si (KR)

Correspondence Address: CANTOR COLBURN, LLP, 55 GRIFFIN ROAD SOUTH, BLOOMFIELD, CT, 06002, US

(21) Appl. No.: 11/188,474

(22) Filed: Jul. 25, 2005

(30) Foreign Application Priority Data
Jul. 26, 2004 (KR) 2004-58211

(51) Int. Cl. F21V 7/04

(52) U.S. Cl. 362/600

(57) ABSTRACT

A flat-type light source device includes a first substrate, an electrode, and a second substrate. The first electrode is disposed on the first substrate, and spaced apart from a second electrode. The second substrate includes a connection portion. The second substrate is combined with the first substrate to form a plurality of discharge spaces. The second substrate has a recess in the discharge space portions. The recess is formed adjacent to an end portion of the second substrate, which is substantially parallel to the discharge space portion. The connection portion includes a contact hole. The first electrode is partially exposed through the connection portion. Therefore, the electrodes may be easily electrically coupled to an inverter, and a size of the flat-type light source device may decrease.

This application claims priority to Korean Patent Application No. 2004-58211 filed on Jul. 26, 2004 and all the benefits accruing therefrom under 35 U.S.C. §119, and the contents of which in its entirety are herein incorporated by reference.

### BACKGROUND OF THE INVENTION

1. Field of the Invention

The present invention relates to a flat-type light source device and a liquid crystal display (“LCD”) device having the flat-type light source device. More particularly, the present invention relates to a flat-type light source device capable of supplying a light to an LCD panel, and an LCD device having the flat-type light source device.

2. Description of the Related Art

An LCD device, in general, displays an image by using liquid crystal. The LCD device is one type of flat panel display devices. The LCD device has various characteristics, such as a thin thickness, a lightweight structure, a low driving voltage, and low power consumption. Therefore, the LCD device has been used in various fields.

An LCD panel of the LCD device emits no light by itself, therefore the LCD panel requires a backlight assembly to provide the LCD panel with light.

The backlight assembly, in general, includes a cold cathode fluorescent lamp (“CCFL”) as a light source. The backlight assembly including the CCFL as the light source is classified into an edge illumination type backlight assembly and a direct illumination type backlight assembly according to the position of the light source.

In the edge illumination type backlight assembly, one or two lamps are disposed at side portions of a light guide plate having a reflecting layer, so that light generated from the lamp or lamps enters the light guide plate through a side face of the light guide plate and is reflected by the reflecting layer to advance toward the LCD panel.

In the direct illumination type backlight assembly, lamps are disposed under the light guide plate facing a light entering face of the light guide plate, a reflection plate is disposed under the lamps, and a diffusion plate is disposed on the light exiting face of the light guide plate to enhance luminance uniformity. Light generated from the lamps enters through the light entering face of the light guide plate, exits the light exiting face of the light guide plate, and is diffused by the diffusion plate.

A backlight assembly has various demerits such as low light-using efficiency, complex structure, high manufacturing cost, and non-uniform luminance due to light loss caused by an optical member such as the light guide plate and the diffusion plate.

Therefore, a flat-type light source device has been developed to solve the above-mentioned problems. The flat-type light source device has low manufacturing cost, and requires only one inverter to generate the surface light. The flat-type light source device includes an electrode for applying a discharge voltage to a plurality of discharge spaces formed by combining an upper substrate with a lower substrate. When a discharge voltage is applied to discharge gas in the discharge spaces, ultraviolet light is generated. The ultraviolet light generated from the discharge gas is converted into visible light by a fluorescent layer formed on an inner surface of one of the upper substrate and the lower substrate.

In addition, the electrode may be classified into an external electrode and an internal electrode. The external electrode is formed on an outer surface of the upper substrate or the lower substrate, and the internal electrode is formed on an inner surface of the upper substrate or the lower substrate. The external electrode may be easily electrically coupled to the inverter, however the flat-type light source device having the internal electrode requires a space for exposing the internal electrode so that the internal electrode Is electrically coupled to the inverter. Therefore, a size of a peripheral region of the flat-type light source device having the internal electrode, which emits no light, increases.

### BRIEF SUMMARY OF THE INVENTION

The present invention provides a flat-type light source device capable of reducing a size of the peripheral region.

The present invention also provides an LCD device having the above-mentioned flat-type light source device.

An exemplary embodiment of a flat-type light source device according to the present invention includes a first substrate, an electrode, and a second substrate. The first substrate has a flat-plate shape. The electrode is formed on the first substrate. The second substrate is combined with the first substrate to form a discharge space, and has a connection portion. A portion of the electrode is exposed through the connection portion.

The second substrate includes a plurality of discharge space portions, a plurality of space division portions, and a sealing portion. The discharge space portions are spaced apart from the first substrate to form the discharge spaces. The space division portions are formed between adjacent discharge space portions so that the space division portions make contact with the first substrate. The sealing portion is formed on a peripheral portion of the discharge space portions and the space division portions to be combined with the first substrate.

One of the discharge space portions, which is adjacent to the sealing portion, has a recess. The recess is formed adjacent to an end portion of the second substrate to expose the electrode via the connection portion positioned at the recess. The end portion of the second substrate is substantially parallel to a longitudinal direction of the discharge space portion. A connection hole is formed through the second substrate that is partially exposed through the recess. In addition, the recess corresponds to the electrode.

The connection portion is a contact hole formed through the second substrate that is partially exposed through the recess. Also, in order to form the connection portion, the sealing portion and the second substrate that is partially exposed through the recess corresponding to the electrode are partially removed.

An exemplary embodiment of an LCD device according to the present invention includes a flat-type light source device, a liquid crystal display panel, and an inverter.

The flat-type light source device includes a first substrate, an electrode formed on the first substrate, and a second substrate combined with the first substrate to form a plurality of discharge spaces. The second substrate has a connection portion through which a portion of the electrode is exposed.

The LCD panel displays an image by using a light generated from the flat-type light source device.

The inverter generates a discharge voltage for operating the flat-type light source device, and is electrically coupled to the electrode through the connection portion.

Also, the LCD device further includes a receiving container to receive the flat-type light source device, a diffusion plate between the flat-type light source device and the liquid crystal display panel, and a fixing member to fix the liquid crystal display panel to the receiving container.

In another exemplary embodiment, a flat-type light source device includes an electrode and a substrate having a first surface contacting the electrode and an opposite second surface, the substrate Including an aperture exposing a section of the electrode, the aperture passing through the first surface to the second surface. Therefore, the electrode is exposed to the exterior of the flat-type light source device through the connection portion formed on the second substrate so that the electrode is electrically coupled to the inverter. In addition, a size of the flat-type light source device decreases.

### BRIEF DESCRIPTION OF THE DRAWINGS

The above and other advantages of the present invention will become more apparent by describing in detail exemplary embodiments thereof with reference to the accompanying drawings, in which:

FIG. 1 is an exploded perspective view showing an exemplary embodiment of a flat-type light source device according to the present invention;

FIG. 2 is a cross-sectional view showing the exemplary flat-type light source device of FIG. 1;

FIG. 3 is a plan view showing the exemplary flat-type light source device of FIG. 1;

FIG. 4 is a perspective view showing an exemplary recess and an exemplary connection portion shown in FIG. 1;

FIG. 5 is a cross-sectional view taken along line I-I′ in FIG. 4;

FIG. 6 is a perspective view showing an exemplary first substrate of FIG. 1;

FIG. 7 is a perspective view showing a portion of the exemplary first substrate of FIG. 6;

FIG. 8 is an enlarged view of portion ‘A’ in FIG. 1;

FIG. 9 is a cross-sectional view taken along line II-II′ in FIG. 8;

FIG. 10 is a perspective view showing another exemplary embodiment of a connection portion according to the present invention;

FIG. 11 is a cross-sectional view taken along line III-III′ in FIG. 10;

FIG. 12 is an exploded perspective view showing another exemplary embodiment of a flat-type light source device according to the present invention;

FIG. 13 is a perspective view showing an exemplary electrode of FIG. 12;

FIG. 14 is a cross-sectional view taken along line IV-IV′ in FIG. 12; and

FIG. 15 is an exploded perspective view showing an exemplary embodiment of an LCD device according to the present invention.

### DETAILED DESCRIPTION OF THE INVENTION

It should be understood that the exemplary embodiments of the present invention described below may be varied and modified in many different ways without departing from the inventive principles disclosed herein, and the scope of the present invention is therefore not limited to these particular following embodiments. Rather, these embodiments are provided so that this disclosure will be through and complete, and will fully convey the concept of the invention to those skilled in the art by way of example and not of limitation.

Hereinafter, the present invention will be described in detail with reference to the accompanying drawings. In the drawings, the thickness of layers, films, and regions are exaggerated for clarity. Like numerals refer to like elements throughout. It will be understood that when an element such as a layer, film, region, or substrate is referred to as being “on” another element, it can be directly on the other element or intervening elements may also be present.

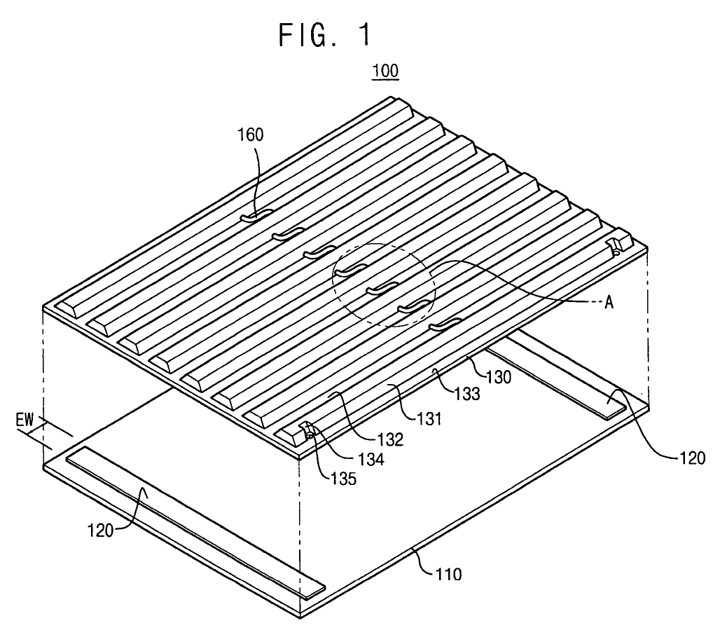

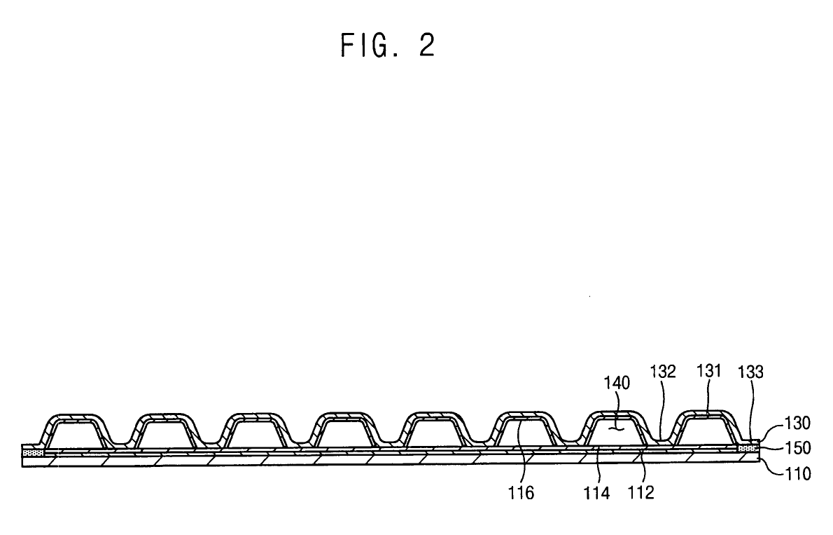

FIG. 1 is an exploded perspective view showing an exemplary embodiment of a flat-type light source device according to the present invention. FIG. 2 is a cross-sectional view showing the exemplary flat-type light source device of FIG. 1.

Referring to FIGS. 1 and 2, the flat-type light source device 100 includes a first substrate 110, a pair of electrodes 120, and a second substrate 130. The first substrate 110 has a flat-plate shape, such as a shape having a rectangularly shaped periphery and opposing flat faces, although other shapes are within the scope of these embodiments. The electrodes 120 are formed on end portions of the first substrate 110. The electrodes 120 are spaced apart from each other. For example, as illustrated, a first electrode 120 is positioned on a first face of the first substrate 110 adjacent a first end of the first substrate 110, and a second electrode 120 is also positioned on the first face but adjacent a second end of the first substrate 110, opposite the first end. The second substrate 130 is combined with the first substrate 110 to form a plurality of discharge spaces 140, and has a connection portion 135. Alternatively, the first and second substrates 110 and 130 may form only one discharge space 140. A portion of the electrodes 120 is exposed through the connection portion 135.

The first substrate 110 has a rectangular flat-plate shape. A glass substrate that transmits visible light and blocks ultraviolet light may be employed as the first substrate 110. While a particular shape and material is described for the first substrate 110, alternate shapes and materials with similar properties would also be within the scope of these embodiments.

The electrodes 120 are disposed such that a longitudinal direction of the electrodes 120 is substantially perpendicular to a longitudinal direction of the discharge spaces 140. The electrodes 120 are overlapped by end portions of the discharge spaces 140. Each of the electrodes 120 has a width EW, measured in a direction parallel to a longitudinal direction of the discharge spaces 140. The electrodes 120 are formed by spraying a conductive material, such as a metallic powder, for example, Cu, Ni, Ag, Au, Al, Cr or a mixture thereof on the first substrate 110. In particular, a mask exposing an area for the electrodes 120 is disposed on the first substrate 110, and the metallic powder is sprayed onto the area to be coated. Then, the mask is removed to form the electrodes 120. Alternatively, the electrodes 120 may be formed on the first substrate 110 by various other methods.

The second substrate 130 is combined with the first substrate 110 to form a plurality of discharge spaces 140. A glass substrate that transmits visible light and blocks ultraviolet light may be employed as the second substrate 130, although other materials with similar properties would also be within the scope of these embodiments. The second substrate 130 comprises a plurality of discharge space portions 131, a plurality of space division portions 132, and a sealing portion 133. Each of the discharge space portions 131 is spaced apart from the first substrate 110 to form each of the discharge spaces 140 between the discharge space portions 131 and the first substrate 110. The space division portions 132 are formed between adjacent discharge space portions 131, and make contact with the first substrate 110. The sealing portion 133 is formed on an outer peripheral portion of the second substrate 130. The first and second substrates 110 and 130 may be combined with each other through an adhesive member disposed between the first and second substrates in the sealing portion 133.

In this embodiment, one of the outermost discharge space portions 131 has a recess 134 adjacent each longitudinal end of the discharge space portion 131. Each recess 134 is formed at an end portion of the second substrate 130 to be disposed over the electrodes 120. In particular, two recesses 134 are formed on the second substrate 130 to expose the electrodes 120, respectively. The two recesses 134 may be diagonally disposed, such as by providing one recess 134 in one corner of the second substrate 130 and another recess 134 in a diagonally opposite corner of the second substrate 130, where one recess 134 would be provided on a first outermost discharge space portion 131, and a second recess 134 would be provided on a second outermost discharge space portion 131 on a opposite side of the second substrate 130. Alternatively, as illustrated, the two recesses 134 may be disposed along a longitudinal direction of the second substrate 130.

The recesses 134 are disposed over each of the electrodes 120. The connection portion 135 is formed at each of the recesses 134. The connection portion 135 corresponds to a contact hole that exposes a portion of the electrodes 120. In the illustrated exemplary embodiment, the contact hole has a circular shape, when viewed on a plane. The first substrate 110 is combined with the second substrate 130, and a portion of the electrode 120 is exposed through the connection portion 135.

Alternatively, the electrodes 120 may be formed on the inner surface of the second substrate 130. When the electrodes 120 are formed on the inner surface of the second substrate 130, the connection portion 135 is formed at the first substrate 110.

The second substrate 130 is formed, for example, through a molding process, where a plate-shaped base substrate is heated and compressed using a mold to form the second substrate having the discharge space portions 131, the space division portions 132, the sealing portion 133, and the recesses 134.

The connection portion 135 may be formed through various ways. For example, the connection portion 135 may be formed through a mechanical drilling or a laser drilling. The connection portion 135 may have various shapes such as a circular shape, a rectangular shape, a polygonal shape, etc., when viewed on a plane.

As shown in FIG. 2, each of the discharge spaces 140 has a trapezoidal shape having rounded corners. Alternatively, the cross-section of each of the discharge spaces 140 may have various shapes such as a semi-circular shape, a rectangular shape, etc.

The second substrate 130, is combined with the first substrate 110, for example, through an adhesive member 150 such as a frit. The frit is a mixture of a glass and a metal, and has a melting point lower than that of the glass of the first and second substrates 110 and 130. The frit is then sintered to form the adhesive member 150. The adhesive member 150 is placed on the sealing portion 133 between the first and second substrates 110 and 130. The adhesive member 150 is not disposed along the space division portions 132 where the space division portions 132 make contact with the first substrate 110. The space division portions 132 make contact with the first substrate 110 by a pressure difference between the discharge spaces 140 and exterior surroundings of the flat-type light source device 100. In particular, after combining the first substrate 110 with the second substrate 130, an air in the discharge spaces 140 is exhausted so as to be in a vacuum state, and then discharge gas for a plasma discharge is injected into the discharge spaces 140. For example, the discharge gas may include mercury (Hg), neon (Ne), argon (Ar), xenon (Xe), krypton (Kr), a mixture thereof, etc. A pressure of the discharge gas in the discharge spaces 140 is about 50 Torr, while the atmospheric pressure outside of the flat-type light source device 100 is 760 Torr. Therefore, a pressure difference is generated between the discharge spaces 140 and the outside of the flat-type light source device 100 so that the space division portions 132 make contact with the first substrate 110.

A connection passage 160 is formed at the second substrate 130 to connect the discharge spaces 140 that are adjacent to each other. At least one connection passage 160 is formed at each of the space division portions 132. The discharge gas injected into the discharge spaces 140 may move between the discharge spaces 140 through the connection passages 160 so that the discharge gas may be uniformly distributed in discharge spaces 140, thereby uniformizing pressure distribution in the discharge spaces 140.

The flat-type light source device 100 further includes a reflective layer 112 formed on an upper surface, the first face, of the first substrate 110, a first fluorescent layer 114 formed on the reflective layer 112, and a second fluorescent layer 116 formed on a lower surface of the second substrate 130 corresponding to the discharge space portions 131. That is, the first fluorescent layer 114 is formed on a surface of the first substrate 110 that faces the second substrate 130, and the second fluorescent layer 116 is formed on a surface of the second substrate 130 that faces the first substrate 110.

The reflective layer 112 is formed on the first face of the first substrate 110 except for a region corresponding to the electrodes 120 that are also disposed on the first face of the first substrate 110. The reflective layer 112 is disposed between the electrodes 120. In this exemplary embodiment, the reflective layer 112 is not formed on the area corresponding to the sealing portion 133, so that an adhesive strength between the adhesive member 150 and the first substrate 110 may be increased. Visible light generated from the first fluorescent layer 114 and the second fluorescent layer 116 is reflected by the reflective layer 112 toward the second substrate 130 to prevent a light leakage.

The first fluorescent layer 114 is formed on the reflective layer 112, and has a substantially same area as the reflective layer 112. That is, the first fluorescent layer 114 is formed on the reflective layer 112, and not on the region corresponding to the electrodes 120 and the sealing portion 133. The first fluorescent layer 114 is formed between the electrodes 120. The second fluorescent layer 116 is formed on a surface of the second substrate 130 that faces the first substrate 110. The second fluorescent layer 116 corresponds to the first fluorescent layer 114. The second fluorescent layer 116 may be formed on the lower surface of the second substrate 130, the surface that faces the first substrate 110, except for the sealing portion 133.

In this exemplary embodiment, the second fluorescent layer 116 is disposed on a surface corresponding to the discharge space portions 131. The first and the second fluorescent layers 114 and 116 convert ultraviolet light generated from discharge gas in the discharge spaces 140 into visible light.

The flat-type light source device 100 may further include a protective layer (not shown). The protective layer is disposed between the second substrate 130 and the second fluorescent layer 116 and/or between the first substrate 110 and the reflective layer 112. The protective layer prevents a chemical reaction between mercury of the discharge gas and the first substrate 110 or between mercury of the discharge gas and the second substrate 130 so that a loss of mercury or blackening phenomenon of the flat-type light source device 100 may be prevented.

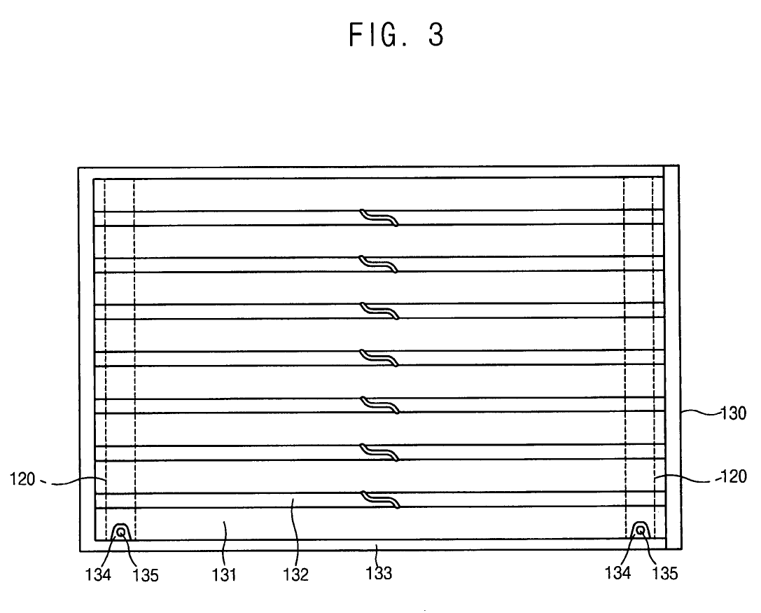

FIG. 3 is a plan view of the flat-type light source device 100 shown in FIG. 1.

Referring to FIG. 3, recesses 134 are provided on the discharge space portions 131. Each of the recesses 134 is adjacent to the sealing portion 133. At least one recess 134 is formed at the discharge space portion 131 so as to be disposed over the electrodes 120. In this exemplary embodiment, two recesses 134 are disposed over the electrodes 120, respectively. As shown in FIG. 3, the recesses 134 are formed on one of the outermost discharge space portions 131. The recesses 134 are formed, for example, on the same discharge space, as in the illustrated embodiment. Alternatively, one of the recesses 134 may be diagonally disposed, as previously described. Two connection portions 135 are formed at the second substrate 130, where each of the connection portions 135 is disposed at the recesses 134, respectively. The connection portions 135 expose a portion of the electrodes 120.

In one embodiment, a width of the sealing portion 133 is only about 3 mm, so that forming the connection portion 135 at the sealing portion 133 would be difficult. Therefore, the recesses 134 are formed at the discharge space portions 131 adjacent to the sealing portion 133, respectively, and the connection portions 135 are formed within the recessed portion 134. As a result, a manufacturing process of the flat-type light source device may be simplified to enhance productivity thereof. In addition, an adhesive strength between the electrodes and the first and second substrates 110 and 130 increases because the sealing portion 133 is not interrupted, and a size of the flat-type light source device 100 decreases because a size of the peripheral region does not need to increase to effectively provide a connection to the internal electrodes 120.

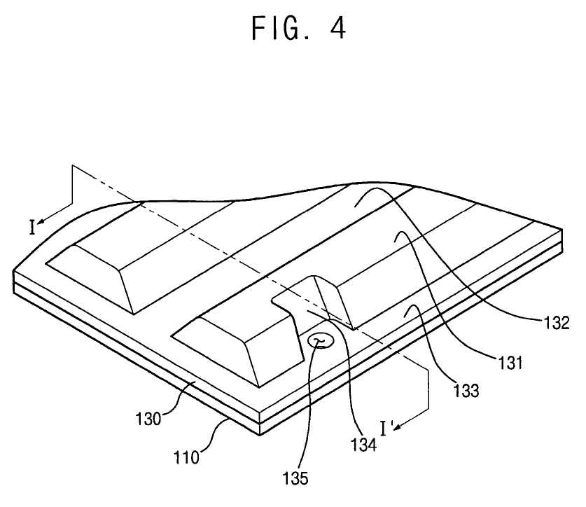

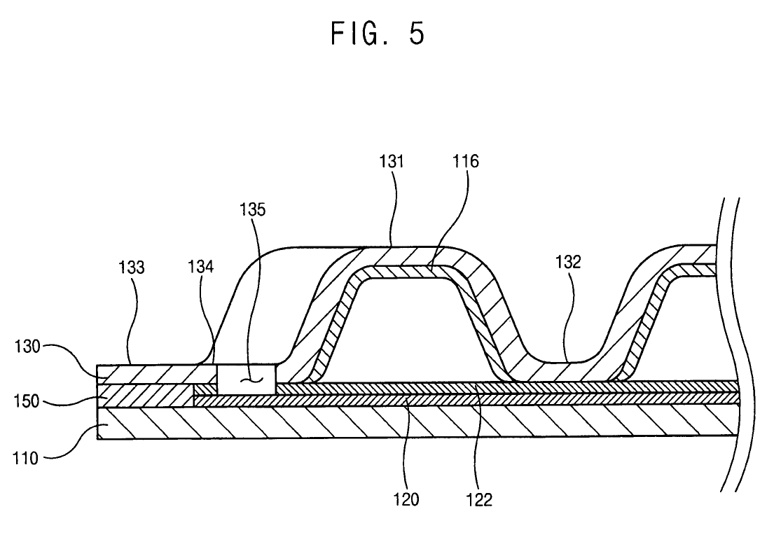

FIG. 4 is a perspective view showing an exemplary recess 134 and an exemplary connection portion 135 of FIG. 1. FIG. 5 is a cross-sectional view taken along line I-I′ in FIG. 4.

Referring to FIGS. 4 and 5, one of the discharge space portions 131, which is adjacent to a sealing portion 133, has a recess 134. The recess 134 is formed adjacent to an end portion of the second substrate 130, corresponding to an end portion of the first substrate 110 that carries an electrode 120. The end portion adjacent to the recess 134 is substantially parallel to the longitudinal direction of the discharge space portion 131. It should be understood that the recess 134 is an indentation within the discharge space portion 131 and that there are no apertures formed in the discharge space portion 131 by the recess 134. The connection portion 135 corresponds to a contact hole through which a portion of the electrodes 120 shown in FIG. 3 is exposed. The second substrate 130 is combined with the first substrate 110 through the adhesive member 150 disposed at the sealing portion 133. The connection portion 135 formed at the recess 134 penetrates the second substrate 130 to expose the electrodes 120. The connection portion 135, in the illustrated embodiment, includes a hole formed in a planar portion of the second substrate 130 located adjacent the recess 134, such as between the recess 134 and the sealing portion 133. The planar portion for the connection portion 135 may be coplanar with the portions of the space division portions 132 that make contact with the first substrate 110.

The recess 134 may have various sizes and shapes in accordance with a required width EW of the electrode 120 and the size of the connection portion 135. In this embodiment, the recess 134 has a smaller width than the electrode 120, and has a larger size than the connection portion 135.

In this embodiment, the flat-type light source device 100 further includes a dielectric layer 122 formed on the electrodes 120. The dielectric layer 122 has a dielectric material to protect the electrodes 120. The electrode 120, the discharge space 140, and the dielectric layer 122 disposed there between define a capacitor. The dielectric layer 122 has an opening exposing a portion of the electrode 120, where the opening corresponds to a location of the connection portion 135 of the second substrate 130.

According to this exemplary embodiment, the flat-type light source device 100 includes the connecting portion 135 so that the electrode 120 is electrically connected to a power line disposed outside of the flat-type light source device 100. The power line may be electrically connected to the electrodes 120 through a soldering, or through other electrical connection devices.

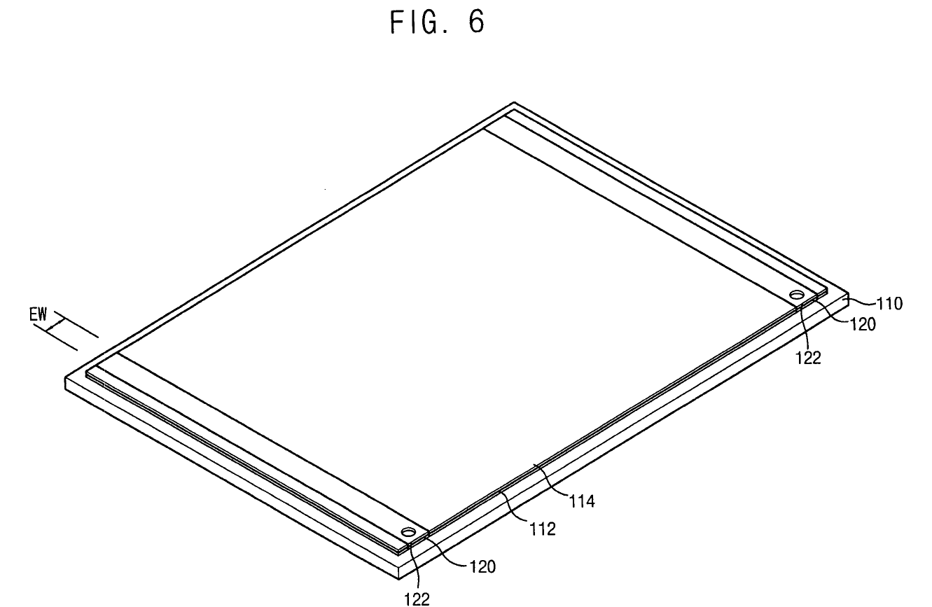

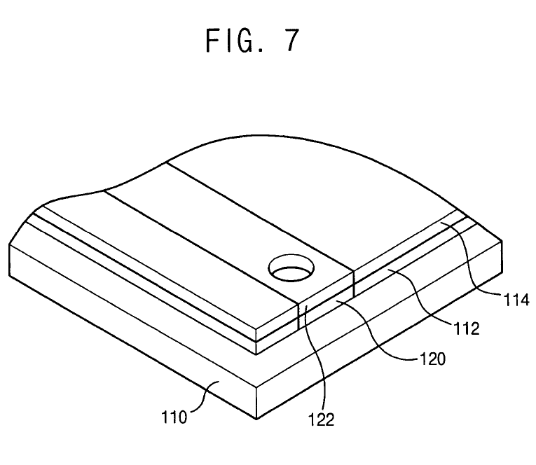

FIG. 6 is a perspective view showing an exemplary first substrate 110 shown in FIG. 1. FIG. 7 is a perspective view showing a portion of the exemplary first substrate 110 of FIG. 6.

Referring to FIGS. 6 and 7, the electrodes 120 are formed on opposite end portions of the first face of the first substrate 110. Each of the electrodes 120 has a band-like shape having the electrode width EW. The dielectric layer 122 is formed on the electrodes 120. The dielectric layer 122 has an opening exposing the electrodes 120. The opening of the dielectric layer 122 corresponds to a location of the connection portion 135 of the second substrate 130. That is, when the second substrate 130 is assembled with the first substrate 110, the connection portion 134 is aligned with the opening in the dielectric layer 122.

A reflective layer 112 is formed on the upper surface, first face, of the first substrate 110 except for a region corresponding to the electrodes 120 and the sealing portion 133. The reflective layer 112 may be formed between the electrodes 120. A first fluorescent layer 114 is formed on the reflective layer 112 and is also not formed on the electrodes 120.

In this embodiment, a sum of a thickness of an electrode 120 and a thickness of the dielectric layer 122 is substantially the same as a sum of a thickness of the reflective layer 112 and a thickness of the first fluorescent layer 114. In such an embodiment, the first fluorescent layer 114 lies substantially flush with the dielectric layer 122 for providing a flat surface for the second substrate 130 to be placed upon.

The space division portions 132 of the second substrate 130 make contact with both the dielectric layer 122 and the first fluorescent layer 114 of the first substrate 110, when the first and second substrates 110 and 130 are combined with each other.

If the total thickness of the electrodes 120 and the dielectric layer 122 were different from the total thickness of the reflective layer 112 and the first fluorescent layer 114, then a stepped portion would be generated at a boundary between the dielectric layer 122 and the first fluorescent layer 114 so that an undesirable space would be formed between the dielectric layer 122 and the space division portion 132.

However, in this exemplary embodiment, the total thickness of an electrode 120 and the dielectric layer 122 is substantially the same as the total thickness of the reflective layer 112 and the first fluorescent layer 114, so that the space division portion 132 is securely combined with the first substrate 110. While the reflective layer 112 is illustrated as having the same thickness as the electrodes 120 and the first fluorescent layer 114 is illustrated as having the same thickness as the dielectric layer 122, it should be understood that the reflective layer 112 may have a greater thickness than the electrodes 120 while the fluorescent layer 114 has a smaller thickness than the dielectric layer 122, so long as the total thickness of the reflective and fluorescent layers 112, 114 is substantially the same as the total thickness of an electrode 120 and the dielectric layer 122. Likewise, the reflective layer 112 may have a smaller thickness than the electrodes 120 while the fluorescent layer 114 has a greater thickness than the dielectric layer 122, so long as the total thickness of the reflective and fluorescent layers 112, 114 is substantially the same as the total thickness of an electrode 120 and the dielectric layer 122.

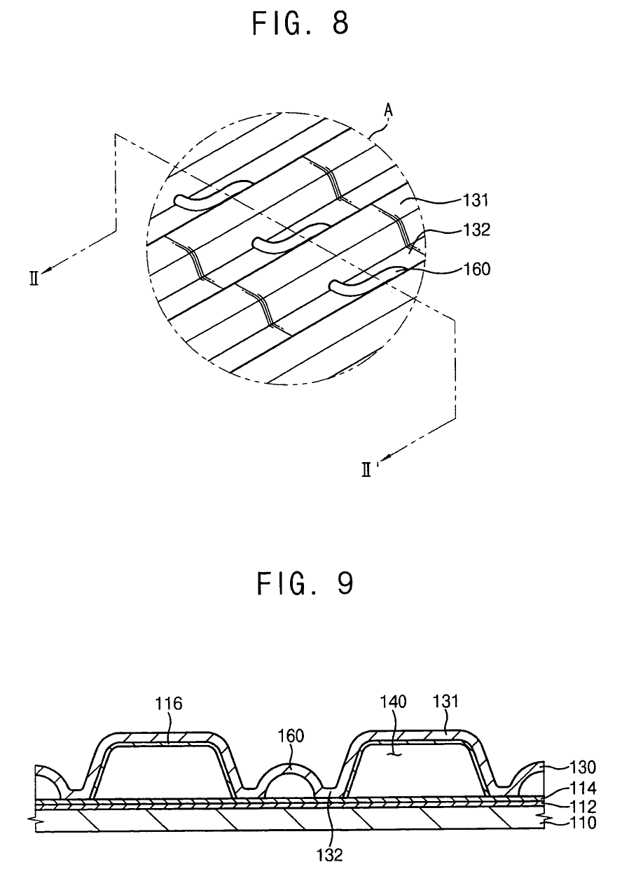

FIG. 8 is an enlarged view of portion “A” shown in FIG. 1. FIG. 9 is a cross-sectional view taken along line II-II′ of FIG. 8.

Referring to FIGS. 8 and 9, at least one connection passage 160 is formed at each of the space division portions 132. While most of each space division portion 132 may be substantially planer for contacting the first substrate 110, a portion of each space division portion 132 of the second substrate 130 is spaced apart from the first substrate 110 to form the connection passage 160, when the first and second substrates 110 and 130 are combined with each other. The connection passage 160, for example, is curved in a diagonal direction of the space division portions 132. In other words, the connection passage 160 may have an S-shape.

When the connection passage 160 has the S-shape, a length of the connection passage 160 increases so as to be longer than a width of the space division portion 132, where a width of the space division portion 132 is measured perpendicularly with respect to a longitudinal length of the space division portions 132. Thus, a path through which plasma flows from one of the discharge spaces 140 to an adjacent discharge space 140 becomes longer. Therefore, a drift of plasma generated by the plasma discharge is reduced.

The connection passage 160, for example, is formed at a central portion of each space division portion 132. Alternatively, the connection passages 160 may be positioned at alternating longitudinal locations of adjacent space division portions 132. The connection passage 160 may have a width of about 2 mm and a height of about 2 mm. Alternatively, more than one connection passage 160 may be formed in each space division portion 132 and they may be evenly distributed within each space division portion 132. The connection passage 160 may have various shapes.

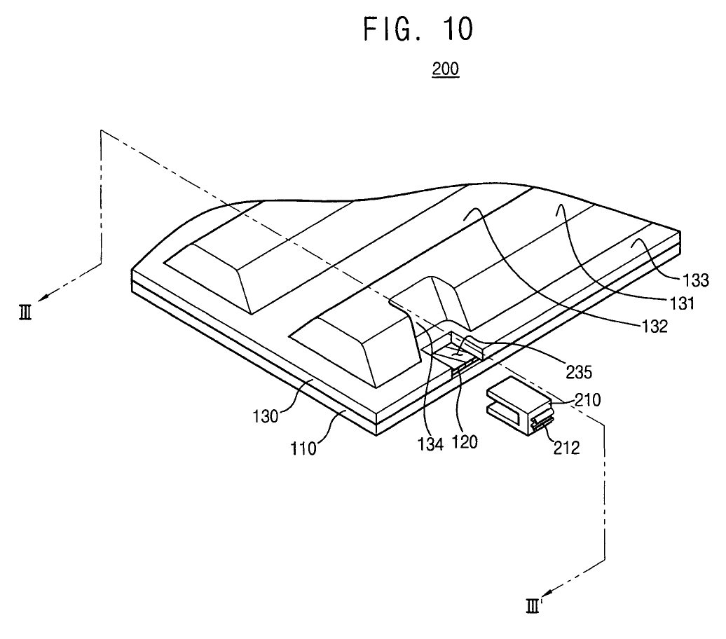

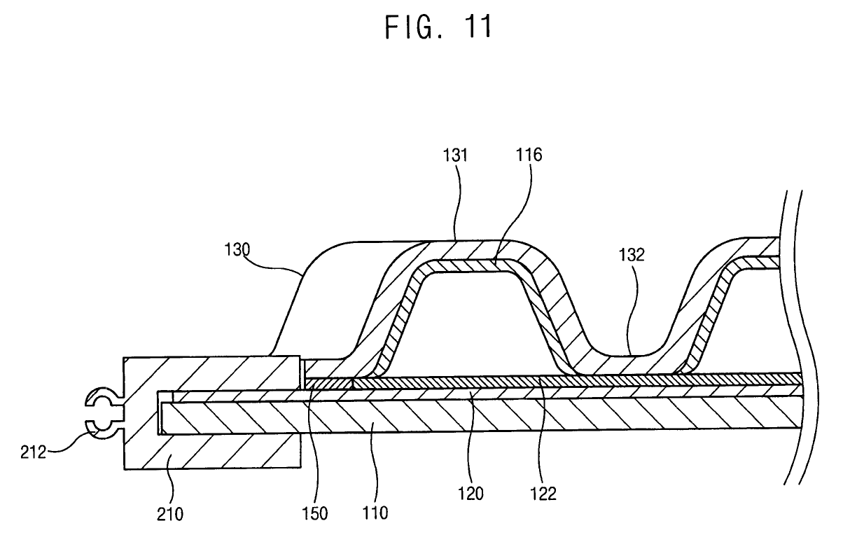

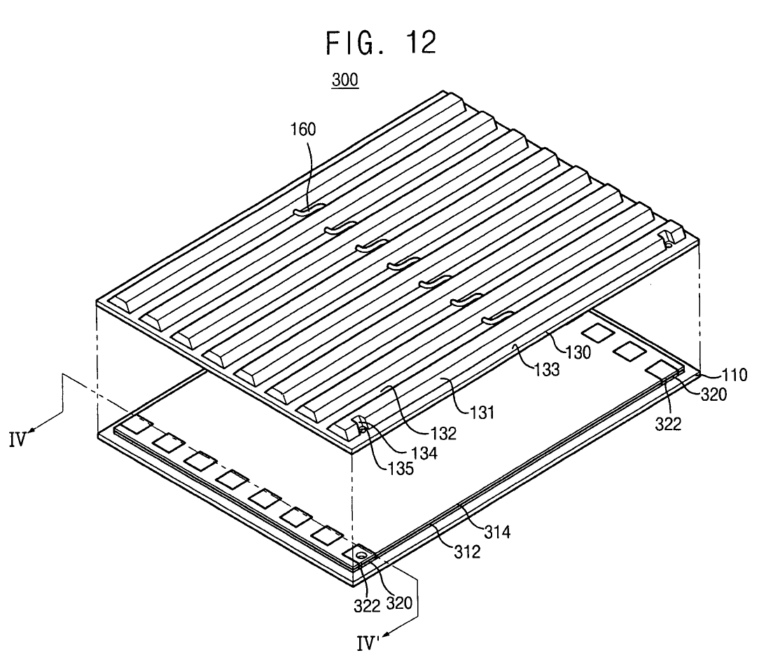

FIG. 10 is a perspective view showing another exemplary embodiment of a connection portion according to the present invention. FIG. 11 is a cross-sectional view taken along line III-III′ of FIG. 10. In this embodiment, the flat-type light source device 200 shown in FIGS. 10 and 11 is substantially the same as the flat-type light source device 100 shown in FIGS. 1 to 9 except for the connection portion. Thus, the same reference numerals will be used to refer to the same or like parts as those described in FIGS. 1 to 9 and any further explanation will be omitted.

Referring to FIGS. 10 and 11, a connection portion 235 in the flat-type light source device 200 is formed by removing a portion of a sealing portion 133 to expose a portion of the electrodes 120. in this embodiment, the sealing portion 133 corresponding to the connection portion 235 is removed so that a portion of the electrodes 120 is exposed through the connection portion 235. The removed portion that defines the connection portion 235 may extend at least partially into the area defined by the recess 134.

An adhesive member 150 is disposed at the sealing portion 133 except for a region corresponding to the connection portion 235 to combine a first substrate 110 with a second substrate 130. The adhesive member 150 is also disposed between the first substrate 110 and a perimeter of the recess 134 of the second substrate 130 for sealing all edges of the second substrate 130 to the first substrate 110.

In this embodiment, each of the electrodes 120 is extended to the sealing portion 133. A dielectric layer 122 is formed on each electrode 120 except for regions corresponding to the connection portions 235. In other words, an end portion of each electrode 120, in an area located below the connection portion 235, is not covered by the dielectric layer 122.

The flat-type light source device 200 further comprises a conductive clip 210. The conductive clip 210 may include a generally U-shaped cross-section, where a first leg of the conductive clip 210 makes contact with the electrode 120, a second leg of the conductive clip 210 makes contact with a lower surface of the first substrate 110, and a connecting portion of the conductive clip 210 connects the first leg to the second leg. The conductive clip 210 is coupled to the first substrate 110 at the position corresponding to the connection portion 235. When the conductive clip 210 is coupled to the first substrate 110, an inner portion of the first leg of the conductive clip 210 makes contact with the electrode 120 that is exposed through the connection portion 235. In order to decrease a size of the flat-type light source device 200, for example, the sealing portion 133 has a width of about 3 mm, and the connection portion 235 is extended toward the recess 134 and past the sealing portion 133 so that the conductive clip 210 may be stably combined with the first substrate 110. The conductive clip 210 may further include a coupling terminal 212 for being coupled to an external power line. The coupling terminal 212 may extend from the connecting portion of the conductive clip 212 and may include a pair of curved power line holders for holding a power line there between. When the conductive clip 210 has the coupling terminal 212, an additional process such as a soldering to connect the power line may be omitted.

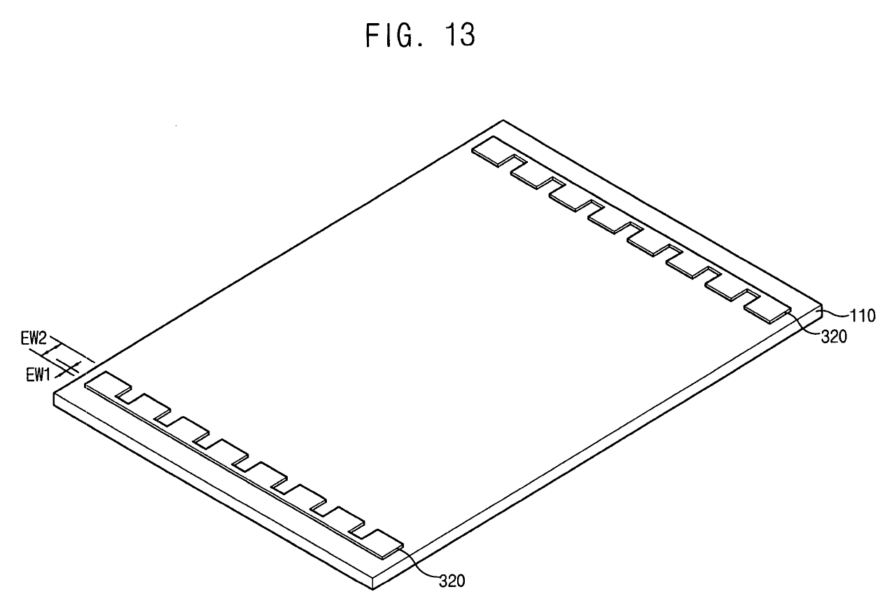

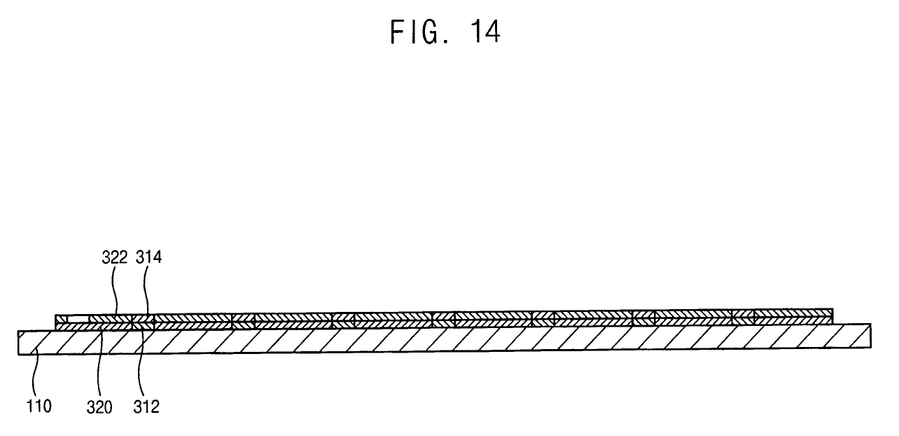

FIG. 12 is an exploded perspective view of another exemplary embodiment of a flat-type light source device according to the present invention. FIG. 13 is a perspective view showing an exemplary electrode shown in FIG. 12. FIG. 14 is a cross-sectional view taken along line IV-IV′ of FIG. 12. In this embodiment, the flat-type light source device 300 shown in FIGS. 12 to 14 is similar to the flat-type light source devices 100 and 200 shown in FIGS. 1 to 11. Thus, the same reference numerals will be used to refer to the same or like parts as those described in FIGS. 1 to 11 and any further explanation will be omitted.

Referring to FIGS. 12 to 14, the flat-type light source device 300 includes electrodes 320, a dielectric layer 322, a reflective layer 312, and a first fluorescent layer 314 formed on a first substrate 110.

As shown in FIG. 13, the electrodes 320 are formed on opposite end portions of the first substrate 110. Each of the electrodes 320 is extended in a direction that is substantially perpendicular to a longitudinal direction of each of the discharge space portions 132. Each of the electrodes 320 is overlapped by the discharge space portions 131. Each of the electrodes 320 has a first width EW1 corresponding to the space division portions 132 and a second width EW2 corresponding to the discharge space portions 131. That is, when the second substrate 130 is assembled onto the first substrate 110, end portions of the space division portions 132 overlie the electrodes 320 in areas having the first width EW1, and end portions of the discharge space portions 131 overlie the electrodes 320 in areas having the second width EW2. The second width EW2 is different from the first width EW1. In this embodiment, the first width EW1 is less than the second width EW2. For example, the first width EW1 is in a range of about 1 to about 2 mm, and the second width EW2 is in a range of about 10 to about 15 mm. Thus, more surface area of the electrodes 320 is located within areas corresponding to the discharge space portions 131 where it is employed to apply voltage to discharge areas 140, and less surface area of the electrodes 320 is located within areas corresponding to the space division portions 132 where the voltage is not necessary other than to pass on the discharge voltages to areas of the electrode 320 having the second width EW2.

A dielectric layer 322 is disposed on the electrodes 320. The dielectric layer 322 is partially opened, such as via an aperture, so that a portion of the electrode 320 is exposed through the opening of the dielectric layer 322. Alternatively, the connection portion 135 may be replaced by the connection portion 235, and a conductive clip may be utilized, as previously described.

A reflective layer 312 is disposed on the first substrate 110 except for an area corresponding to the electrodes 320 and the sealing portion 133 of the second substrate 130. The reflective layer 312 may be disposed between the electrodes 320. A first fluorescent layer 314 is disposed on the reflective layer 312.

In this embodiment, when the first substrate 110 is combined with the second substrate 130, the space division portions 132 make contact with the first fluorescent layer 314. The reflective layer 312 and the first fluorescent layer 314 that is disposed on the reflective layer 312 are disposed on the first substrate 110 corresponding to the space division portions 132. Each of the first and second widths EW1 and EW2 are small with respect to a length of the first substrate 110, so a total thickness of the flat-type light source device 300 may be determined regardless of a lack of electrode material in certain areas containing the electrode 320 having the first width EW1 of the first substrate 110 so that the flat-type light source device 300 is still considered to have uniform thickness. Therefore, the space division portions 132 make contact with the first fluorescent layer 314. In this embodiment, as in the previous embodiment, a total thickness of each of the electrodes 320 and the dielectric layer 322 is substantially the same as a total thickness of the reflective layer 312 and the first fluorescent layer 314, thus providing a substantially flat surface for the second substrate 130 to be placed upon.

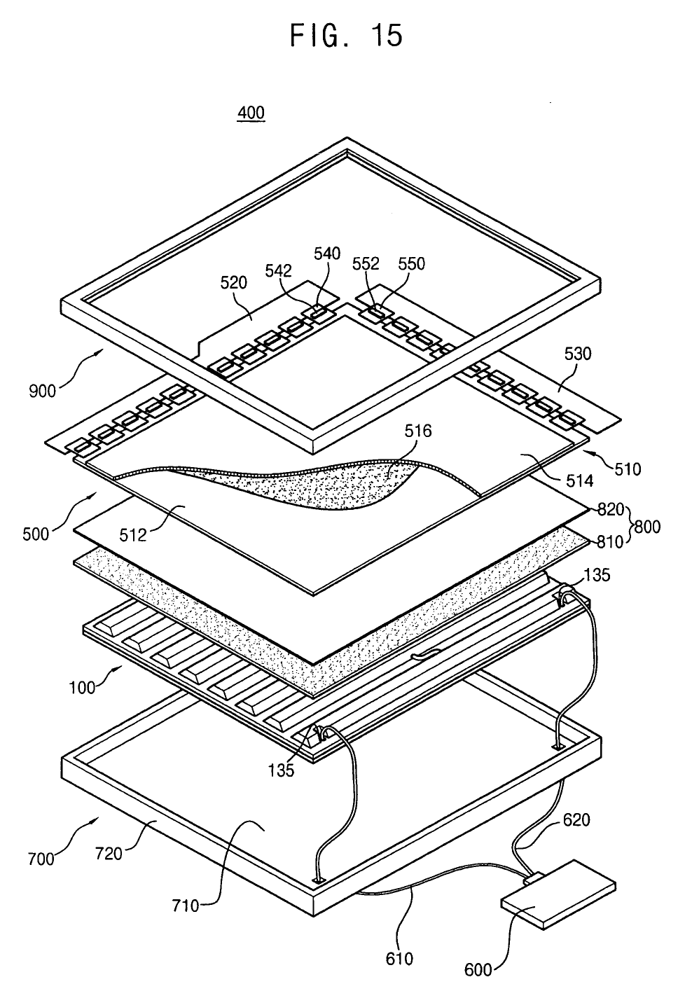

FIG. 15 is an exploded perspective view showing an exemplary embodiment of an LCD device according to the present invention. A flat-type light source device 100 shown in FIG. 15 is substantially the same as the light source devices described with respect to FIGS. 1 to 14. Thus, the same reference numerals will be used to refer to the same or like parts as those described in FIGS. 1 to 14 and any further explanation will be omitted. While the flat-type light source device 100 is shown in FIG. 15, it should be understood that any of the above described embodiments, or combinations thereof, of a flat-type light source device described with respect to FIGS. 1-14 may be employed in the LCD device 400.

Referring to FIG. 15, the LCD device 400 includes, in part, the flat-type light source device 100, a display unit 500, and an inverter 600.

The display unit 500 includes an LCD panel 510, a data printed circuit board (“PCB”) 520, and a gate PCB 530. The data and gate PCBs 520 and 530 generate driving signals to drive the LCD panel 510. Driving signals generated from the data and gate PCBs 520 and 530 are applied to the LCD panel 510 through a data flexible circuit film 540 and a gate flexible circuit film 550. For example, a tape carrier package (“TCP”) or a chip on film (“COF”) may be employed as the data and gate flexible circuit film 540, 550. Also, the data and gate flexible circuit films 540 and 550 further comprise a data driving chip 542 and a gate driving chip 552 controlling the driving signals, respectively, to apply the driving signals to the LCD panel 510 at a proper time.

The LCD panel 510 includes a thin film transistor (“TFT”) substrate 512, a color filter substrate 514, and a liquid crystal layer 516. The color filter substrate 514 faces the TFT substrate 512. The liquid crystal layer 516 is disposed between the TFT substrate 512 and the color filter substrate 514.

Although not illustrated in detail for clarity, the LCD panel 510 may function in a manner as will now be described. The TFT substrate 512 has a transparent glass plate and a plurality of switching devices arranged in a matrix shape. Each of the switching devices may be a TFT formed on the transparent glass plate. A source electrode of the TFT is electrically connected to one of a plurality of data lines. A gate electrode of the TFT is electrically connected to one of a plurality of gate lines. A drain electrode of the TFT is electrically connected to a pixel electrode.

The color filter substrate 514 includes a transparent plate, a red color filter, a green color filter, and a blue color filter. The red, green, and blue color filters are formed on the transparent plate through a photolithography process, a photo process, etc. The common electrode is formed on the transparent plate having the red, green, and blue color filters formed thereon. The common electrode includes an optical transparent and electrically conductive material, such as, but not limited to, indium zinc oxide (“IZO”), indium tin oxide (“ITO”).

When voltages are applied to the gate and source electrodes of the TFT, the TFT is turned on so that an electric field is generated between the pixel electrode of the TFT substrate 512 and the common electrode of the color filter substrate 514. The arrangement of liquid crystal molecules of the liquid crystal layer 516 is varied in response to the electric field applied thereto, and thus an optical transmittance of the liquid crystal 516 may be altered, thereby displaying the image.

An inverter 600 generates a discharge voltage to operate the flat-type light source device 100. The inverter 600 inverts alternating voltage from an exterior of the LCD device 400 into discharge voltages to operate the flat-type light source device 100. The discharge voltages generated from the inverter 600 are applied to the electrodes 120 of the flat-type light source device 100 through a first power supply line 610 and a second power supply line 620. The first and second power supply lines 610 and 620 are electrically connected to the electrodes 120 that are exposed through the connection portion 135, by using a method such as a soldering. When the electrodes 120 are electrically connected to conductive clips 210, the first and second power supply lines 610 and 620 are electrically connected to the conductive clips 210, such as through the coupling terminal 212.

The LCD device 400 further includes a receiving container 700 for receiving the flat-type light source device 100, an optical member 800 for increasing a luminance of a light generated from the flat-type light source device 100, and a fixing member 900 for fixing the LCD panel 510 with respect to the receiving container 700.

The receiving container 700 includes a bottom plate 710 and a plurality of sidewalls 720. The bottom plate 710 receives the flat-type light source device 100. The sidewalls 720 are protruded upwardly from sides of the bottom plate 710 to form a receiving space. The receiving container 700 may further include an insulating member (not shown) for insulating the flat-type light source device 100.

The optical member 800 is disposed between the flat-type light source device 100 and the LCD panel 510. When the light generated from the flat-type light source device 100 passes through the optical member 800, the luminance of the light increases and is uniformized. The optical member 800 includes a diffusion plate 810 for diffusing the light generated from the flat-type light source device 100. The diffusion plate 810 has a plate-shape having a regular thickness. The diffusion plate 810 is spaced apart from the flat-type light source device 100 by a predetermined distance. The optical member 800 may further include at least one prism sheet 820 on the diffusion plate 810. The prism sheet 820 guides the light generated from the diffusion plate 810 toward the LCD panel 510 to enhance the brightness of the light when viewed from a front of the LCD panel 510. Alternatively, the optical member 800 may further include a diffusion sheet on the prism sheet 820 to diffuse the light. The application of more or less optical sheets within the backlight assembly would also be within the scope of these embodiments.

The fixing member 900 is combined with the receiving container 700. The fixing member 900 covers sides of the LCD panel 510 to fix the LCD panel 510 on the optical member 800. The fixing member 900 protects the LCD panel 510 from an impact that may occur on an exterior of the LCD panel 510, and also prevents a drifting of the LCD panel 510 relative to the optical member 800 and light source device 100.

The LCD device 400 may further include a fixing means (not shown) for fixing the flat-type light source device 100 within the receiving container 700 and the optical member 800 on the receiving container 700 and for guiding the LCD panel 510 onto the receiving container 700.

According to the present invention, the flat-type light source device includes the recess for the connection portion at the discharge space portion that is adjacent to the sealing portion so that the inverter is electrically coupled to the electrodes. In addition, the size of the flat-type light source device may decrease.

This invention has been described with reference to the exemplary embodiments. It is evident, however, that many alternative modifications and variations will be apparent to those skilled in the art in light of the foregoing description. Accordingly, the present invention embraces all such alternative modifications and variations as fall within the spirit and scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A flat-type light source device comprising:
a first substrate;
an electrode disposed on the first substrate; and
a second substrate forming a discharge space together with the first substrate, the second substrate having a connection portion through which a section of the electrode is exposed.

2. The flat-type light source device of claim 1, further comprising in the second substrate:
a plurality of discharge space portions spaced apart from the first substrate to form the discharge space;
a plurality of space division portions, each of the space division portions disposed between adjacent discharge space portions, the space division portions contacting the first substrate; and
a sealing portion contacting the first substrate through an adhesive member disposed between the sealing portion and the first substrate, the sealing portion corresponding to edge portions of the second substrate.

3. The flat-type light source device of claim 2, wherein an outermost discharge space portion adjacent to the sealing portion has a recess contacting the first substrate, the connection portion formed at the recess.

4. The flat-type light source device of claim 3, wherein the recess is disposed over the electrode.

5. The flat-type light source device of claim 4, wherein the connection portion includes a contact hole penetrating the second substrate and exposing a section of the electrode.

6. The flat-type light source device of claim 4, wherein a portion of the sealing portion disposed over the electrode is partially removed to form the connection portion.

7. The flat-type light source device of claim 6, further comprising a conductive clip coupled to the first substrate at the connection portion and contacting a section of the electrode exposed through the connection portion.

8. The flat-type light source device of claim 7, further comprising, in the conductive clip, a first leg contacting the section of the electrode exposed through the connection portion, a second leg contacting a lower surface of the first substrate, and a connector connecting the first leg to the second leg.

9. The flat-type light source device of claim 8, further comprising a coupling terminal extending from the connector of the conductive clip.

10. The flat-type light source device of claim 3, wherein the electrode is substantially perpendicular to a longitudinal direction of the discharge space, and the electrode is overlapped by the discharge space.

11. The flat-type light source device of claim 10, further comprising:
a dielectric layer disposed on the electrode to protect the electrode;
a reflective layer disposed on the first substrate;
a first fluorescent layer disposed on the reflective layer; and
a second fluorescent layer disposed on the second substrate corresponding to the discharge space.

12. The flat-type light source device of claim 11, wherein the dielectric layer is opened to expose a section of the electrode, the section corresponding to the connection portion.

13. The flat-type light source device of claim 11, wherein a total thickness of the reflective layer and the first fluorescent layer is substantially same as a total thickness of the electrode and the dielectric layer.

14. The flat-type light source device of claim 10, wherein the electrode has a first width at the space division portions, and a second width greater than the first width at the discharge space portions.

15. The flat-type light source device of claim 14, further comprising:
a dielectric layer disposed on the electrode of the discharge space portions;
a reflective layer disposed on the first substrate;
a first fluorescent layer disposed on the reflective layer; and
a second fluorescent layer on the discharge space portions of the second substrate facing the first substrate.

16. The flat-type light source device of claim 15, wherein the dielectric layer is opened to expose a portion of the electrode, the portion corresponding to the connection portion.

17. The flat-type light source device of claim 15, wherein the first width is in a range from about 1 mm to about 2 mm, and the second width is in a range from about 10 mm to about 15 mm.

18. The flat-type light source device of claim 3, wherein each of the space division portions further comprises at least one connection passage connecting adjacent discharge spaces.

19. The flat-type light source device of claim 1, comprising a first electrode adjacent a first end of the first substrate, a second electrode adjacent a second end of the first substrate, a first connection portion exposing the first electrode, and a second connection portion exposing the second electrode.

20. The flat-type light source device of claim 1, further comprising an indentation in a discharge space portion of the second substrate, the connection portion formed adjacent the indentation.

21. A liquid crystal display device comprising:
a flat-type light source device comprising a first substrate, a first electrode and a second electrode on the first substrate, and a second substrate combined with the first substrate to form a discharge space, the electrodes spaced apart from one another, and the second substrate having a connection portion through which a section of each of the first and second electrodes is exposed;
a liquid crystal display panel that displays an image using light generated by the flat-type light source device; and
an inverter that generates a discharge voltage to operate the flat-type light source device, the inverter electrically coupled to the first and second electrodes through the connection portion.

22. The liquid crystal display device of claim 21, wherein the second substrate comprises:
a plurality of discharge space portions spaced apart from the first substrate to form a plurality of discharge spaces;
a plurality of space division portions, each of the space division portions disposed between adjacent discharge space portions, the space division portions contacting the first substrate;
a sealing portion contacting the first substrate through an adhesive member disposed between the sealing portion of the second substrate and the first substrate, the sealing portion corresponding to edge portions of the second substrate; and,
a recess formed in one of the discharge space portions adjacent to the sealing portion, the recess formed adjacent to an end portion of the second substrate.

23. The liquid crystal display device of claim 22, wherein the connection portion includes a contact hole formed on the second substrate, the connection portion partially exposed through the recess.

24. The liquid crystal display device of claim 22, wherein the sealing portion disposed over the first electrode is partially removed to form the connection portion.

25. The liquid crystal display device of claim 22, wherein the first and second electrodes are substantially perpendicular to a longitudinal direction of the discharge space portions, and the first and second electrodes are overlapped with the discharge spaces.

26. The liquid crystal display device of claim 25, further comprising:
a dielectric layer disposed on the first and second electrodes of the discharge space portions;
a reflective layer disposed on the first substrate and between the first and second electrodes;
a first fluorescent layer disposed on the reflective layer; and
a second fluorescent layer on the discharge space portions of the second substrate facing the first substrate.

27. The liquid crystal display device of claim 25, wherein each of the first and second electrodes has a first width at the space division portions, and a second width greater than the first width at the discharge space portions.

28. The liquid crystal display device of claim 27, further comprising:
a dielectric layer disposed on the first and second electrodes, a portion of the dielectric layer exposing a section of the electrode, the portion of the dielectric layer corresponding to the connection portion;
a reflective layer disposed on the first substrate;
a first fluorescent layer disposed on the reflective layer; and
a second fluorescent layer disposed on the second substrate corresponding to the discharge space portions.

29. The liquid crystal display device of claim 22, further comprising:
a receiving container that receives the flat-type light source device;
a diffusion plate disposed between the flat-type light source device and the liquid crystal display panel; and
a fixing member that fixes the liquid crystal display panel to the receiving container.

30. A flat-type light source device comprising:
an electrode; and,
a substrate having a first surface contacting the electrode and an opposite second surface, the substrate including an aperture exposing a section of the electrode, the aperture passing through the first surface to the second surface.

31. The flat type light source device of claim 30, further comprising a discharge space portion of the substrate overlapping the electrode, an indentation in the discharge space portion, the aperture located adjacent the indentation.
